(19) United States
(12) Patent Application Publication
(10) Pub. No.: US 2009/0127119 A1
(43) Pub. Date: May 21, 2009

(54) ELECTRONIC COMPONENTS ASSOCIATED AND APPARATUS FOR DEIONIZATION AND ELECTROCHEMICAL PURIFICATION AND REGENERATION OF ELECTRODES

(75) Inventors: Matthew Ward Witte, Pueblo, CO (US); Brian C. Large, Pueblo, CO (US); Michael Andrew Lawler, Troy, MI (US); James R. Fajt, Station, TX (US)

Correspondence Address: DARBY & DARBY P.C., P.O. BOX 770, Church Street Station, New York, NY, 10008-0770, US

(73) Assignee: THE WATER COMPANY LLC, Pueblo, CO (US)

(21) Appl. No.: 11/718,464

(22) PCT Filed: Oct. 28, 2005
(86) PCT No.: PCT/US05/38909

§ 371 Date: May 5, 2008

Related U.S. Application Data
(60) Provisional application No. 60/624,268, filed on Nov. 2, 2004.

(51) Int. Cl. B03C 9/00

(52) U.S. Cl. 204/662; 204/663; 204/661

(57) ABSTRACT

An electrical system of an electrochemical purification apparatus is presented. The system includes a plurality of electrodes for deionizing fluids passing through the electrodes, a power supply connected to the electrodes, the power supply providing power to the electrodes while maintaining a predetermined current, a predetermined voltage, or a power within some range, a programmable logic controller, connected to the power supply, for controlling the power supply, and a monitoring device connected to the programmable logic controller for delivering data regarding the system to the programmable logic controller.

### CROSS REFERENCE TO RELATED APPLICATION

The present application claims the benefit of U.S. patent application Ser. No. 60/624,268, filed Nov. 2, 2004, which is hereby incorporated by reference in its entirety.

### BACKGROUND OF THE INVENTION

An example of an apparatus for deionizing and purifying fluid has a tank containing a plurality of deionization cells formed from two different types of non-sacrificial electrodes. One type is formed from a carbon-based inert carbon matrix (ICM). The electrode of this type when energized extracts ions from an aqueous solution and retains the ions on the electrode. The other type does not extract ions or it retains less ions, and therefore, is classified as a non-absorptive type (“non-ICM electrode”). The electrode of the second type is typically formed from carbon cloth, graphite, titanium, platinum and other conductive materials that do not degrade in the electric field in the aqueous solution.

A voltage potential is established between a pair of adjacent electrodes by connecting one side of a power supply to one electrode and the other side to an adjacent electrode. Fluids containing various anions and cations, electric dipoles, and/or ionized suspended particles are subjected to a stack of electrodes. The ICM electrodes attract particles or ions of the opposite charge to remove them from the fluid.

To deionize fluid, an electrical circuit for a capacitive deionization system is provided in a patent to Tran et al. (U.S. Pat. No. 6,309,532). This electrical system provides a voltage programmable DC power supply and has a resistive load and a switch connected in parallel across the positive and negative terminals of the power supply to discharge or regenerate an electrochemical cell that contains electrodes.

In operation, the switch is open when the cell with the electrodes is used to deionize. Purification is accomplished by pulling the electrolytes from the fluid to the electrodes in the cell. In order to start the regeneration process, the power supply is turned off and the switch is closed to provide a path for a discharge current.

### SUMMARY OF THE INVENTION

The present invention is directed to an electrochemical purification system (or apparatus), which deionizes and purifies fluid containing various ionic or polar impurities. In one embodiment of the present invention, the system includes a plurality of electrodes for deionizing fluids passing through, passing by or standing between the electrodes. A power supply is connected to the electrodes and provides power to the electrodes, while maintaining a predetermined current, a predetermined voltage, or a power within a predetermined range. The system further includes a programmable logic controller that is connected to the power supply for controlling the power supply and a monitoring device that is connected to the programmable logic controller for delivering data regarding the system to the programmable logic controller. The power supply is also connected to any solenoids, valves, pumps, etc., that may be present in the system for controlling these components.

In a first embodiment, the system can include a communication interface to allow remote monitoring and operation. For example, a digital communication interface connected to the programmable logic controller allows external access to the programmable logic controller to extract data contained in the programmable logic controller and to remotely reprogram the programmable logic controller. Remote operation and monitoring allows for separation between the user and operator, with the operator certifying purification operations and effluent purity.

In a second embodiment, the system provides for automatic safety and security monitoring and response. For example, a monitoring device can include a moisture (leakage) sensor for determining whether an area in the electrical chemical system has been compromised by the solution to be treated. If a certain, predetermined level of leakage is detected by the programmable logic controller through the leakage sensor, which would be located where no fluid/moisture should be found, the programmable logic controller can protect the system by shutting down the system, particularly by closing off fluid input. To maintain the security and integrity of the system, so that certification procedures are reliable and authentic, the system can include a scram circuit for disabling the system when the system senses any security violation such as unauthorized movement of the system, breach of the system enclosure, or tampering with system monitors. The safety and security monitors will, in a preferred embodiment, notify the external controller to ensure a timely service call, repair, or other remedial action.

In a third embodiment, the programmable logic controller may instruct one power supply to provide one level of voltage to its corresponding set of electrodes and instruct at least another power supply to provide a different level of voltage to its corresponding set of electrodes. Varying voltage among different electrodes in the system increases overall efficacy, and allows for efficient operation under varying input solution conditions.

In a fourth embodiment, the system includes a regeneration protocol, including one or more of (1) a monitor system for determining when to initiate a regeneration cycle automatically; (2) an electrical regeneration step, which can include voltage reversal at electrodes, shorting electrodes, or combinations of reversal and shorting; (3) a regeneration waste removal process; and (4) a rinsing process. In a specific example, regeneration proceeds by reversing the polarity of the electrodes to take impurities off the electrodes, then shorting the electrodes through the current controller to keep the impurities from attaching to the electrodes of opposite polarity.

The system can further include one or more of a flow controller, connected to the programmable logic controller, for controlling an inlet device and an outlet device, which respectively control the access of fluid to and from the electrodes; and an electrical current controller, connected to the programmable logic controller, for controlling electrical current flow within the system.

The monitoring device of the system may, for example, include a current or voltage monitor connected between the power supply and the electrodes to monitor current flow delivered to the electrodes from the power supply. The electrodes themselves may act as voltage, resistivity, or conductivity sensors to monitor how the electrodes have become loaded with ions extracted from passing fluid through the electrodes. In one example, if the current (or voltage) monitor detects that the current (voltage) flowing to the electrodes goes past a certain, predetermined threshold level or falls within a predetermined range, the programmable logic controller can execute an electrode regeneration process to regenerate the electrodes.

The monitoring device can further include one or more conductivity monitors for measuring conductivity of fluid entering, in, and/or leaving the electrochemical purification apparatus to monitor the conductivity of the fluid passing into, through, and out of the electrodes. Conductivity monitors provide one measure of the degree of contamination of a solution, and the degree of purification, as well as the operation of the electrodes in the system.

One or more pH monitors for measuring pH of fluid and one or more chemical sensors for sensing chemical impurities can further be included in the apparatus. These monitors can be located in the inlet, outlet, and/or inside the system, for the same reason as the conductivity monitors, as described above.

The monitoring device can further include an inlet fluid monitor for measuring a flow rate of fluid entering a tank containing the electrodes and an outlet fluid monitor for measuring a flow rate of fluid exiting the tank containing the electrodes.

The monitoring device can further include a fluid level sensor for detecting a fluid level in a tank containing the electrodes; an external fluid level sensor for sensing a fluid level of a tank external to the electrochemical purification system; and a chemical sensor for sensing chemical impurities of fluid in the tank external to the electrochemical purification system.

The monitoring device can still further include, as part of an anti-tampering device, a motion sensor or a light sensor, for example, for detecting unwanted motion or unauthorized internal lighting of the electrochemical purification system. If a threshold level of motion or light is detected by the programmable logic controller, the scram circuit can disable the system from operating.

The monitoring device can further include a flow sensor or an array of flow sensors to detect flow of fluid at a designated location in the electrochemical purification system. If a threshold level of fluid flow is detected at the designated location by the programmable logic controller from the flow sensor, the programmable logic controller can instruct the inlet device to decrease or increase the fluid flow. The controller can also redirect flow within the apparatus upon input from the flow sensors or other sensors.

The monitoring device can further include a flow rate loss monitor for monitoring a back pressure of flowing fluid in a tank containing the electrodes. If the back pressure exceeds a threshold value, the programmable logic controller sends out a warning to signify a need to regenerate the electrodes or takes other corrective action to moderate the condition.

The programmable logic controller can further control an air pump, a recirculation pump, drain valves, rinse solenoids, and warning/safety devices to alert a user of any abnormal conditions. The controller can be connected to a keypad, a display device, and/or any other input/output device.

Other features and advantages of the present invention will be apparent from the following detailed description when read in conjunction with the following drawings.

### BRIEF DESCRIPTION OF THE DRAWINGS

FIG. 1 is a schematic drawing of one embodiment of an electrical system of the present invention, showing components that are controlled by a programmable logic controller;

FIG. 2 shows an array of power supplies controlled by a programmable logic controller according to an embodiment of the present invention;

FIG. 3 shows monitors and sensors controlled by a programmable logic controller according to another embodiment of the present invention;

FIG. 4 shows a flow controller controlled by a programmable logic controller according to another embodiment of the present invention; and

FIG. 5 shows an electrical current controller controlled by a programmable logic controller according to an embodiment of the present invention.

### DETAILED DESCRIPTION

The electrochemical purification system of the present invention provides a number of advantages over prior art systems, including one or more of the following features: (1) remote operation and monitoring; (2) automatic safety and security controls with remote notification of safety and security events; (3) multiple, independent control of individual electrode polarity and voltage, using multiple power supplies; and (4) an automated regeneration protocol. In a preferred aspect, one or various combinations of these technical features operate a system using porous, absorptive electrodes, operated in either a flow-through, flow-past, or combined fluid flow path. In particular, the system operates with electrodes, such as those electrodes described in U.S. Pat. No. 5,977,015, as well as those described in U.S. Application Ser. No. 60/607,028, filed on Sep. 3, 2004, attorney reference No. 20085/0201040-US0, both of which are hereby incorporated by reference in their entireties.

The term “fluid” refers to an aqueous or polar solution for treatment in a system of the invention. Generally, fluids will be aqueous, since water treatment is an important industrial and environmental issue. However, as will be clear from the description, the invention permits treatment of polar non-aqueous liquids containing ions or polar materials.

The term “materials” refers generally to matter in the fluid that can be removed by electrodes. Such materials include ions, ionizable compounds, polar or polarizable compounds, and microorganisms.

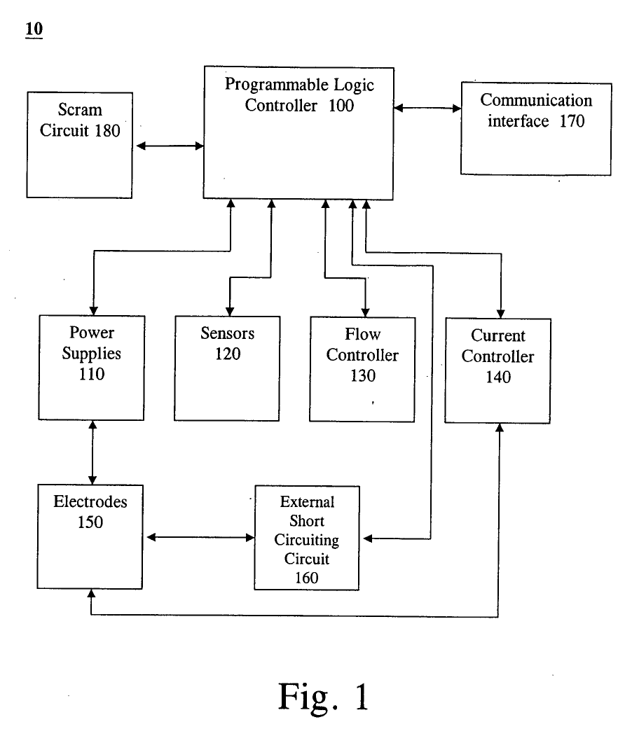

FIG. 1 shows an electrical system 10 of an electrochemical purification apparatus, according to an embodiment of the present invention. The electrical system 10 includes a programmable logic controller 100 for centrally controlling the various electronic components of the system 10 and for receiving status information from the components. The system 10 further includes one or an array of power supplies 110, a predetermined number of various monitors and sensors 120, a flow controller 130, and a current controller 140, all of which can be controlled by the programmable logic controller 100.

An example of an electrochemical purification apparatus can be found in U.S. Pat. No. 5,925,230 and U.S. Pat. No. 6,090,259, which are incorporated herein by reference. Before operating the purification apparatus to begin purifying fluid, the controller 100 checks a series of device statuses, including, for example, ascertaining that a tank for purifying fluid is full, that certain valves are closed to prevent unwanted leakage, and that a shorting relay for short circuiting electrodes is not closed. These checks assure that the electrochemical purification apparatus is ready to operate.

The array of power supplies 110 are connected to a set number of electrodes 150, which when energized purify or deionize an aqueous solution passing through, passing by or standing between the electrodes by extracting ions and ionized impurities from the solution and retaining them in the electrodes.

The various monitors and sensors 120 can have signal conditioners that can translate signals that come directly from the sensors into voltage and current levels that the logic controller 100 can interpret and understand. Through the controller 100, the monitors and sensors 120 and the flow controller 130 are used to control the path of raw fluid and the rate of flow and/or frequency of water changeover through the electrochemical purification apparatus. For example, they can control how many electrodes 150 the fluid passes through, at what rate the fluid passes through them, how long the fluid is in contact with the electrodes, and what order of the electrodes the fluid comes in contact with.

The system 10 can further include an external short circuiting circuit 160 controlled by the current controller 140 to short circuit the electrodes 150 when it becomes necessary to regenerate the electrodes, which is accomplished by releasing the accumulated ions from the electrodes into waste fluid as described below in detail.

The system 10 can further include a digital communication interface 170, such as a modem, for communicating with the system remotely. The programmable logic controller 100 can be controlled through the digital communication interface 170 to be reprogrammed to adjust the control of the components or to remotely extract status information of the system. For example, the controller 100 can be remotely programmed by, for example, downloading programs and changing any set parameters used in the programs, such as current or voltage levels. The order of purification steps can be easily changed by reprogramming the controller 100. In another example, the controller 100 can be called up through the digital communication interface 170 to find out how much fluid the apparatus has treated and to bill by the volume of treated fluid.

A scram circuit 180 can also be included in the system 10. The circuit 180 can disable the system 10, rendering it inoperable by anyone but an authorized user, when the system detects a deliberate, unauthorized tampering through, for example, a security sensor as a part of the monitor and sensors 120.

The arrows in FIG. 1 indicate that the various electronic components are under the control of the programmable logic controller 100. The monitors and sensors 120 and digital communication interface 170 can further communicate with the programmable logic controller 100 to deliver status information to it.

Preferably, the system 10 can be enclosed and sealed to be fluid tight to prevent fluid from invading into the electrical components which can cause a malfunction and/or potential damage.

One example of how the system 10 operates is given as follows. After an initial reset (start), the programmable logic controller 100 can read the various statuses of sensors 120 (sensors for detecting fluid level, waste and treated fluid levels, pH at an inlet and at an outlet, voltage, current, and so forth). If any faults are detected by the reading of the sensors 120, the device can be shut down and can be re-initialized to start the process over again. If no fault is detected at the sensors, the apparatus is checked to determine if it is filled with fluid. If it is not, a valve is opened to allow fluid into the apparatus and the apparatus is restarted.

If it is filled with fluid, the apparatus is checked by the programmable logic controller 100 to determine if it is in a regeneration mode. If it is in the regeneration mode, the programmable logic controller 100 prohibits the release of the fluid and instructs the apparatus to proceed with the next step of the regeneration mode. After the regeneration mode is completed, the waste fluid is discarded and the apparatus is restarted.

If the apparatus is not in the regeneration mode and the apparatus is filled with fluid, then the operating power is applied to start treating the fluid. Through the sensors, the programmable logic controller determines whether the treated fluid is ready to be released or not. If it is ready, the treated fluid is released into a holding tank and the apparatus is restarted. This completes a cycle of treatment.

This cycle represents one operational process. There are many other variations to the operation that are within the scope of the present invention. For example, in another operational mode, the fluid may pass continuously through the apparatus for uninterrupted treatment of the fluid and without regard as to whether a target fluid chemistry has been achieved. Likewise, the determination of when to regenerate the apparatus can be based on the amount of water passed or even on the amount of time since the last regeneration.

Each of the electronic components of the electrical system 10 is described in greater detail below in reference to the figures provided.

### Power Supply

The power supplies 110 of FIG. 1 can be arranged in parallel and each power supply 110 can be configured to provide a predetermined current, a predetermined voltage, or a range of power to a set of electrodes 150. The predetermined current or voltage can be a range. The source of the power supplies 110 can be line voltage, e.g., 110/120 volts or 220/240 volts, a conventional battery, a solar cell, a fuel cell, or any other type of generator. The source can be man-powered, wind-powered, or fluid-powered.

In one embodiment of the invention, if the power supply 110 is controlled by the programmable logic controller 100 to provide a constant current to the electrodes 150, the voltage is varied according to the purity of the solution. As the solution passes through, passes by or resides (dwells) between the electrodes 150, impurities are removed from the solution and retained in the electrodes. The extractions of ionized impurities cause the conductivity of the solution to decrease and the resistance to rise because of less and less ionized particles in the solution to contribute to the conduction. Also, as the electrodes accumulate ions or ionized particles, the conductivity can change. Therefore, to provide a constant current, the voltage (and the power) would have to change to compensate for the change in resistivity. Finally, the voltage needed to keep the constant current saturates or reaches a steady state. The saturation of the voltage may indicate that the solution has become sufficiently clean to be let out and to introduce the next volume of solution for purification.

In another embodiment of the invention, if the power supply 110 is controlled by the programmable logic controller 100 to provide a constant voltage to the electrodes 150, the current is varied. As the solution is passed through, passed by or dwelled between the electrodes one or more times, the solution becomes cleaner and the resistance rises. To keep a constant voltage, the rise of the resistance dictates that the current must be decreased, and therefore, the amount of power needed goes down. After a steady state current is reached (i.e., no change in the current needed to maintain the constant voltage), the solution may be sufficiently clean to let in the next volume of solution into the purification apparatus.

One advantage of supplying a constant current to the electrodes 150 is that as the voltage, and consequently the power, is raised to maintain the constant current, certain impurities are efficiently removed because the rate of removal of ions depends on the voltage. On the other hand, the advantage of supplying a constant voltage is that as the current is decreased to maintain the constant voltage, less and less power is required because the power decreases as the current decreases. Also, because the rate of removal of ions depends on the voltage, the constant voltage would allow a greater control of the equilibrium state of ions in the solution.

Alternatively, in another embodiment of the invention, because the power is a product of voltage and current, it can be controlled to a constant value or within a specified range while suitably varying the current, the voltage, or both, over time to optimize the purification process. For example, the power supply 110 can be controlled by the programmable logic controller 100 to supply a low voltage and a high current to the electrodes initially, but the voltage can be ramped up and the current inversely ramped down over time to optimize the removal of various impurities, which may have functional dependencies on voltage such that some impurities are more efficiently removed at a particular voltage than another.

In general, the power can also be controlled to vary over time. The programmable logic controller 100 can ramp the power up or down over time to optimally control the purification process given the particular application.

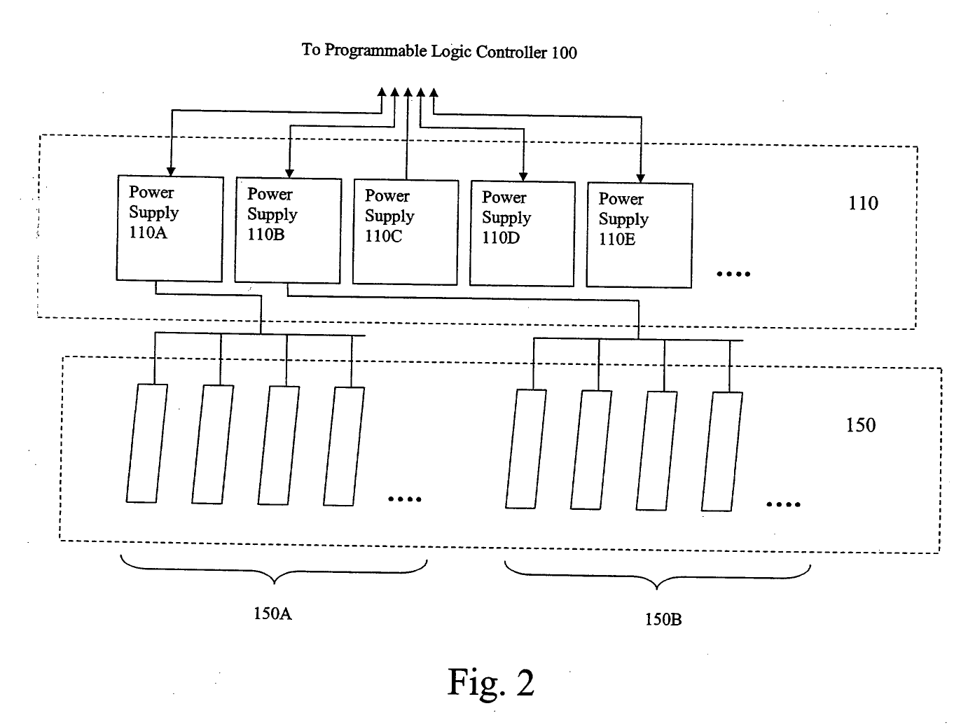

FIG. 2 shows an array of parallel power supplies 110A . . . 110E and each of these is connected to a set of electrodes 150A and electrodes 150B of, for example, opposite polarity. A variation would be that all electrodes are of one polarity and only one electrode may be of opposite polarity—there could other variations so long as at least one electrode is of one polarity and another electrode is of an opposite polarity. One power supply can deliver power to 1 to N electrodes and another power supply can deliver power to N+1 to 2N electrodes and so on. The electrodes of FIG. 2 do not represent a particular arrangement but are merely an illustration of a plurality of set of electrodes being connected to a plurality of power supplies. For example, the electrodes 150A and 150B can be arranged alternatively in a parallel fashion so that any two adjacent electrodes are of opposite polarity to each other. The one polarity set of electrodes, for example, the electrodes 150B, can be connected together to have a common reference voltage point. The voltage supplied to the electrodes 150A can be varied according to the power supply tied to those electrodes. Thus, the voltage supplied to the electrodes 150 can be varied to optimally remove the positive and negative ions and/or positively and negatively charged particles.

The voltage provided by one power supply, for example, 110A, may differ from that provided by another power supply 110B. A low voltage may be more efficient in removing negatively charged ions and can cause the solution to become basic. A higher voltage may be more efficient in removing positive charged ions and can cause the solution to become acidic. Therefore, by controlling one power supply 110A to provide a low voltage to one set of electrodes 150 and another power supply 110B to provide a higher voltage to another set of electrodes 150, a tuned rate of removal of both positive and negative ions can be achieved since these different ions are better targeted.

The power supplies can be fixed within the system but they can also be modular. The power supplies 110A . . . 110E are examples of modular systems. Power supplies and electrodes may be added or subtracted based on the need dictated by the volume and the quality of raw fluid treatment and operated independently or together. Thus, it is possible to have one power supply deliver power to a set of electrodes in a first cell tank to purify/deionize raw fluid, while a second cell tank is being regenerated.

The power supplies 110A . . . E can be driven by a common 110V AC outlet or can be customized to be driven at a different voltage to suit the power appropriate for the facility to which the electrochemical purification apparatus is provided. The apparatus can be driven at one-half to five volts but the applicable voltage should not be limited to this range.

### Electrodes

The electrodes 150 are preferably of a non-sacrificial type and the fluid, e.g., effluent, can flow through the electrodes, can flow past the electrode surfaces or dwell between the electrodes depending upon the precise construction of the electrodes 150.

The electrode 150 can be made of a carbon matrix that includes in its composition a carbonized product of a polymerization monomer, a cross-linker, and a catalyst, where the product is free of a carbon fiber reinforcing agent that is added to a mixture of the polymerization monomer and the cross-linker during the process of making the electrodes. A wire or a fitted piece for connecting a wire may be, for example, soldered directly onto the electrodes such that the molten solder is expanded into the carbon matrix to make a mechanical connection. Alternatively, instead of soldering the wire or the fitted piece, it can be threaded directly into the carbon matrix free of any solder or a molten metal. Alternatively, a conductive non-sacrificial material can be held in contact with the electrode via any mechanical means.

The shape of the electrodes 150 can be square, triangular, rectangular, trapezoidal, elliptical, circular, rod shaped, or flat shaped or any number of other shapes including regular and irregular shapes. The geometry of the electrodes may be shaped according to the constraint of the electrochemical purification apparatus.

According to one embodiment, one or more of the electrodes 150 can be formed in accordance with the disclosure of PCT patent application No. PCT/US05/31362, filed Sep. 2, 2005, which is hereby incorporated by reference in its entirety.

The electrodes 150 can themselves be used as resistivity or conductivity sensors. Power to the electrodes can be temporarily interrupted to determine how much residual voltage or charge has built up on the electrodes 150 in a solution with known resistivity. The amount of charge that is developed on the electrodes 150 can be correlated to the amount of ions that have been removed from the fluid. And this in turn may also be used to gauge the next period for regenerating the electrodes or gauge when the electrodes 150 have been sufficiently regenerated.

### Monitors and Sensors

The monitors and sensors 120 include various electronic components under the control of the programmable logic controller 100 for monitoring and sensing the various statuses of the purification apparatus.

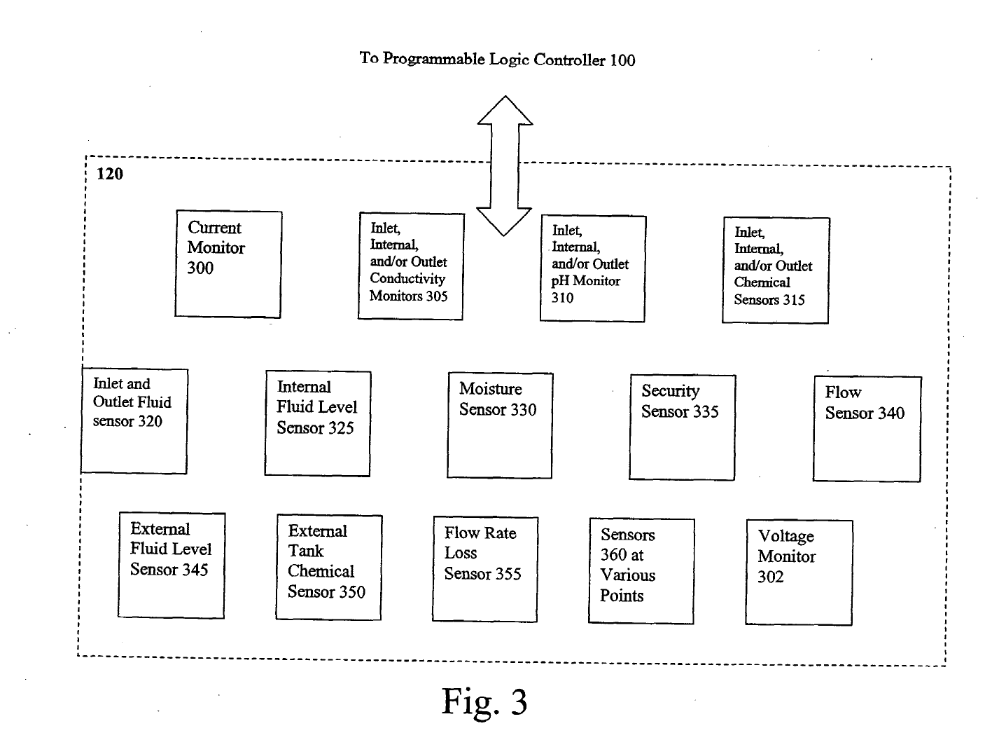

As shown in FIG. 3, the monitors and sensors 120 can include a current monitor 300 and/or a voltage monitor 302 connected between the power supply 110 and the electrodes 150 to monitor current flow delivered to or voltage applied to the electrodes 150 from the power supply 110. In an example of regenerating electrodes, if the current monitor 300 (or the voltage monitor 302) detects that the current flowing (or the voltage applied) to the electrodes 150 has reached a predetermined threshold level or falls within a predetermined range, the programmable logic controller 100 can execute an electrode regeneration process to reverse the polarity of the electrodes 150 and/or to short circuit the electrodes 150 to let the accumulated ions flow back into the waste fluid, which is subsequently disposed of after the process is completed. The current monitor 300 (or the voltage monitor 302) may also determine when conditions are sufficient to proceed to the next step within a multi-step regeneration process.

A conductivity monitor 305 for measuring conductivity of the solution entering, in, or exiting the electrochemical purification apparatus can also be included. For example, prior to entering the system, the monitor 305 can detect the conductivity of the fluid and determine the electrode conditions necessary for purification. Then, during deionization, the conductivity (consequently, the resistivity) of the fluid can be constantly measured to determine the current or the voltage needed to maintain the constant voltage or the constant current, respectively, across the electrodes 150 of opposite polarity. As the solution exits the tank, a conductivity sensor 305 can be used to determine the purity of the solution and if the solution is of a sufficient purity, which does not have to be ultra pure, it can be delivered to an external tank and if not, it may be recirculated back into the internal tank for further deionization/purification or passed on to a second purification apparatus. The conductivity monitor 305 can also determine when conditions are sufficient to proceed to the next step within a multi-step regeneration process.

A pH monitor 310 for measuring pH of fluid and a chemical sensor 315 for sensing chemical impurities can further be included in the electrochemical purification apparatus. The pH and, especially, the chemical sensor(s) can be used to evaluate the fluid to be purified, the state of the fluid in the system, and the fluid exiting the system. These various monitoring steps permit automatic selection of operating parameters, and determination of system performance.

The conductivity monitor 305, the pH monitor 310, or the chemical sensor 315 can also be used together or independently to determine the rate the raw fluid becomes purified. If the rate that the raw fluid becomes purified slows considerably, then this may indicate that the electrodes 150 may need to be regenerated.

The system of the invention has a number of user-oriented advantages. By interfacing with a remote operation center, the conductivity sensors, pH monitors, and chemical sensors at an inlet can provide, in addition to the information needed to the apparatus to determine the starting parameters of fluid coming in, a basis to generate a bill for a customer using the electrochemical purification apparatus. Similarly, by monitoring one or more parameters of the purified fluid exiting the system, the remote operator can independently certify the quality of effluent produced by the user. Such certification can support compliance with environmental regulations, and may become a necessary element of such compliance. Because the third party operator/certifier is an independent entity, the certification has greater reliability, and can obviate the need for extensive verification testing by government agencies.

The monitors and sensors 120 can further include an inlet fluid sensor 320 for measuring a flow rate of fluid entering a tank containing the electrodes and an outlet fluid sensor 320 for measuring a flow rate of fluid exiting the tank containing the electrodes. The sensors 320 feed back the information to the programmable logic controller 100 to control the flow of fluid into the tank containing the electrodes 150.

The monitors and sensors 120 can further include an internal fluid level sensor 325 for detecting a fluid level in a tank containing the electrodes 150. The internal fluid level sensor 325 sends information to the programmable logic controller 100 to indicate that a desired (inputted or prescribed) level of fluid is present in the tank containing the electrodes 150. The internal fluid level sensor 325 can be, for example, a float, an electrical switch, a scale to measure the weight of the tank fully loaded and so on. If/when the prescribed amount of fluid level is attained, the sensor 325 sends signals to the programmable logic controller 100, which in turn tells the flow controller 130 to shut the inlet valve off to terminate the fluid supply to the tank. In the hierarchy of controls performed by the controller 100, the fluid level control is given the highest priority because of the importance of having the prescribed amount of fluid present in the tank in order to properly operate the purification apparatus.

In another embodiment, the system 10 can further contain an external fluid level sensor 345 for sensing a fluid level of a tank external to the electrochemical purification system 10. The external fluid level sensor 345 can act as a backup system to ensure that flow controller 130 is acting properly. An external chemical sensor 350 can be provided in the external tank to sense chemical impurities of treated fluid in the external tank. The external chemical sensor 350 can be a back-up to the internal chemical sensor 315 to ensure that a designated purity of treated fluid is coming out from the purification apparatus 10.

To check for any leakages at a location where fluid should not be present, the system 10 can further include a moisture sensor 330 for determining whether an area in the electrochemical purification apparatus has been compromised by fluid/moisture. If a predetermined level of moisture is detected by the programmable logic controller 100 through the sensor 330, the controller operates to protect the system 10 by shutting the system 10 down. The moisture sensor 330 should be monitored frequently to prevent unwanted fluid in prescribed locations. If there is fluid (i.e. moisture), under the control of the programmable logic controller 100, the system 10 can go into a safety mode and shut down the whole system to prevent any more unwanted fluid from infiltrating into the system. The programmable logic controller 100 can also direct to externally divert the fluid present in the apparatus to prevent further damage as well as flooding of the area where the system is in operation. Detection of a leak and automatic shut-down or diversion can prevent environmental discharge and possible violation of environmental codes and regulations.

The sensor 330 can also be connected to an alarm to warn of unwanted moisture in the system 10. In case of emergency, such as when the alarm goes off, the system 10 can further have an emergency switch for manually shutting the whole system down. That is, the system 10 can have a master on/off button when a catastrophic failure at the plant occurs or the system fails to responds to commands or the internal sensors fail; an operator or someone at site could hit a single button and lock all the valves and prevent any additional fluid spill.

Alternatively, in accordance with the remote operation embodiment of the invention, the moisture alarm can notify the remote operator through the communications interface, permitting remote shut-down or repair. This automatic notification could result in more rapid dispatch of service personnel to perform any necessary repairs.

The system 10 can still further include a security sensor 335, such as a motion or light sensor, as part of an anti-tampering device, for detecting unauthorized tampering of the electrochemical purification apparatus 10. For example, if a threshold level of motion is detected by the programmable logic controller 100, the scram circuit 180 can disable the system 10 and/or the controller may send out signals through the digital communication interface 170 that the apparatus has been tampered with. The motion sensor is provided to promote safety (e.g. prevent possible electric shock), for certification of device integrity, and to prevent theft.

Similarly, a light sensor can be provided to detect any unauthorized opening of the apparatus, which would be covered and closed during normal operation. If an intruder opens the apparatus and lets the light in where there should not be any light, the light sensor can send signals to the programmable logic controller 100. The controller 100 can instruct the scram circuit 180 to disable the system 10 and/or the controller can remotely warn of the unauthorized tampering of the apparatus through the digital interface 170.

The system 10 can further include a flow sensor 340 to detect flow of fluid at a designated location in the electrochemical purification system. If a threshold level of fluid flow is detected at the designated location by the programmable logic controller 100 from the flow sensor, the controller 100 can instruct an inlet device for allowing fluid into the tank containing the electrodes 150 to increase or decrease the fluid flow.

The system 10 can further include a flow rate loss monitor 355 for monitoring a back pressure of flowing fluid in a tank containing the electrodes. If the back pressure exceeds a threshold value, the programmable logic controller 100 can send out a warning to signify a need to regenerate the electrodes 150, may decrease the system pressure, or take other cautionary actions to avoid damage to the electrodes.

With the monitors and sensors 120, a series of diagnostics of the apparatus can be performed. For example, if the reading of pH monitor 310 or the chemical sensor 315 exceeds a preset limit on a volume of inlet fluid, then the operation can be halted. In another example, the voltage and current supplied to the electrodes 150 can also be diagnosed. If a constant current is supplied and for some reason the voltage exceeds a preset limit, the operation may be suspended. Likewise, the status information/condition (voltage, current, pH, conductivity, fluid quality in the external tank, etc.) can be stored in the controller 100 at the time that the voltage exceeded the limit so that cause of the abnormality can be determined later on. In another example of diagnostics, if the controller 100 instructs to output fluid and there is still a zero reading on the outlet fluid sensor 320, that may trigger an alarm to alert a technician to address the problem. In general, a series of diagnostics can be provided based on quantifiable parameters so that if one or more parameters exceed an expected range, then alerts could be set to point to problems that need to be addressed.

In one working example, the apparatus includes 20 ICM electrodes arranged such that the fluid is introduced and removed via a single port. The fluid injected into the system varies in conductivity from 300-700 uS and in pH from 7.0-8.5. During treatment, the programmable logic controller (PLC) instructs the power supplies to drive 2.1A through the treatment cell. The PLC will allow the apparatus to release the fluid from the tank when it has reached a quality level of 40 uS corrected for pH. The PLC maintains a running tally of (inlet fluid purity*amount of inlet fluid) minus (outlet fluid purity*amount of outlet fluid). When the PLC determines that the apparatus has removed a predetermined amount of total impurities, it triggers the apparatus to begin a regeneration sequence.

### Flow Controller

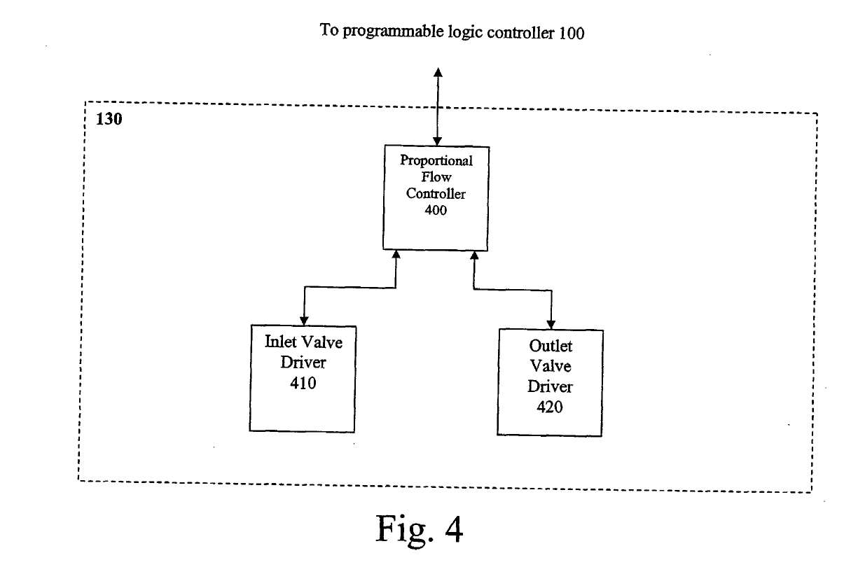

The system 10 can further include the flow controller 130 as shown in FIG. 4. The flow controller 130 is connected to the programmable logic controller 100 for controlling an inlet valve driver 410 and an outlet valve driver 420, which respectively allows fluid into and out of a tank containing the electrodes 150. The flow controller 130 can control other valves that divert fluid into different directions. The inlet valve driver 410 and the outlet valve driver 420 can include solenoids to control the inlet and outlet valves, which may be, for example, butterfly valves, ball valves, or spool valves. The outlet and inlet may even be gate orifices instead of valves. A relay and other additional hardware may be used to convert a low power logic source into high power signals to drive the solenoids that move the inlet and outlet valves. The inlet sensors 320 and the outlet sensors 320 sense the amount of solution leaving and flowing into the tank. The outflow and the inflow of fluid may be adjusted accordingly. For example, when the solution in the tank is determined to be clean after a sufficient amount of purification has taken place, the solution may be let out through the outlet valve and the rate of outflow may be monitored by the outlet sensor 320. At the same time, the inlet valve can be opened up to let in the next volume of solution and monitored by the inlet sensor 320. The inlet valve and the outlet valve may be adjusted accordingly so that the rate of outflow is equal to the rate of inflow.

Any degree of fluid quality can be achieved by controlling the circulation rate through the apparatus and the rate that fluid exits the apparatus through the flow controller 130. For example, pH and conductivity can be controlled to any desired levels by recirculating the solution through the apparatus by feedback loops from the pH and conductivity sensors 305 and 310 to the programmable logic controller 100 to the flow controller 130. If the pH and conductivity sensors 305 and 310 shows that the fluid coming off from the purification tank is still not sufficiently within a specified range of pH and conductivity, the fluid may be sent back to the tank for further purification. If the fluid is of sufficient pH and conductivity, the fluid can be diverted by the fluid controller 130 to a holding tank and a fresh solution may be introduced into the tank for purification.

The flow controller 130 can also divert the fluid completely away from the tank in case of emergency. When the moisture sensor 330 senses moisture in an area of the apparatus not designed to contain any fluid, the flow controller 130 upon instruction from the programmable logic controller 100 may divert fluid away from the tank and/or drain out any fluid from the electrochemical purification apparatus. The flow controller 130 can also be utilized to drain waste fluid appropriately when the electrodes are being regenerated.

### Current Controller

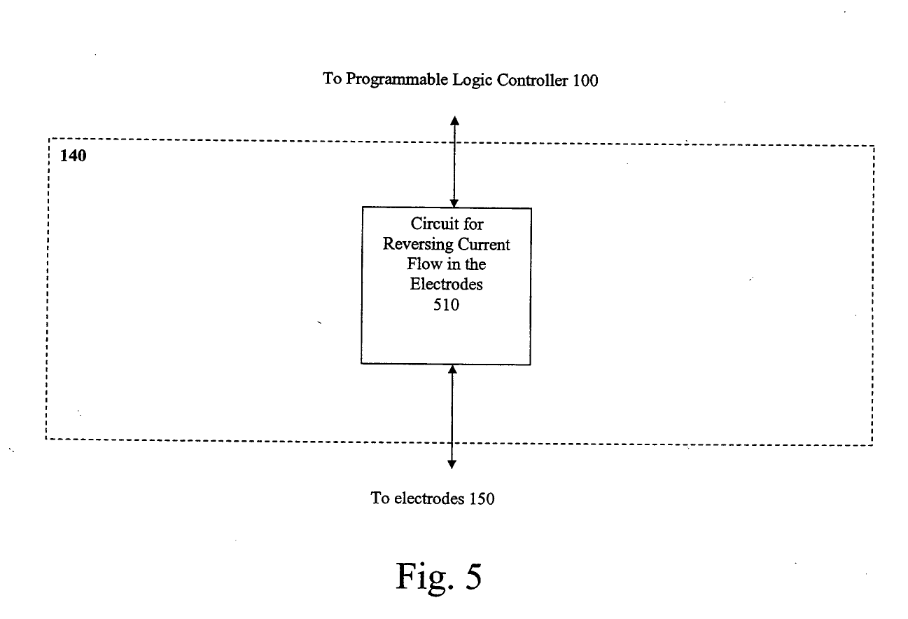

The current controller 140 as shown in FIG. 5 is connected to the programmable logic controller 100 for controlling current flow within the system 10. In one embodiment of the invention, during a procedure to regenerate the electrodes 150, a current flow reversing circuit 510 can be used to reverse the flow of the current to change the polarity of the electrodes. When this happens the ions trapped in the electrodes migrate back out into the solution. As the ions migrate back into the solution, the conductivity of the solution increases. If the reverse current is continued to be applied, the conductivity may start to decrease as the ions now migrate and attach to the opposite electrodes. Therefore, at an appropriate point such as when the conductivity reaches a maximum, the electrodes can be short circuited by a relay circuit 160 and the waste fluid that contains the ions migrated from the electrodes may be drained. In another embodiment of the present invention, the positive and negative electrodes 150 are separated from one another and regenerated against another set of non-sacrificial electrodes in order to eliminate cross-contaminating cations and anions on the working electrodes.

In one working example, the PLC begins regenerating the electrodes by disengaging the power supply and then moving the electrodes into separate tanks such that cation removal and the anion removal electrodes are isolated from one another. The tanks contain opposing non-sacrificial electrodes that are dedicated to the task of regeneration. The PLC then applies current to the electrodes in such a polarity as to repel their collected ions back into solution. The PLC determines that this phase of regeneration is complete when the conductivity monitor indicates that the electrolyte has reached a maximum level. At this point, the PLC commands the valve to release the electrolyte. The electrodes can then be moved back into their operating positions to continue in forward operation. It will be appreciated that any combinations of physical motions of operating electrodes, regeneration electrodes and tanks are covered within the scope of the present invention as described herein.

### Digital Communication Interface

The digital communication interface 170, which can, for example, be a modem or RS-232, GPIB, IEEE488, Ethernet, or any one of wireless communication devices, is connected to the programmable logic controller. The digital communication interface 170 allows external access to the programmable logic controller 100 to extract status information of the system 10 obtained through the sensors and to remotely reprogram the programmable logic controller. Any electronic components under the control of the programmable logic controller 100 can be controlled remotely from a remote station such as a laptop computer through a phone line.

The controller 100 can be remotely accessed to reprogram the regeneration routine so that the parameters, such as the threshold values that will initiate the regeneration process, can be changed in order to accommodate, for example, changes in the fluid quality.

If necessary, the parameters at which the various sensors and monitors operate can be changed remotely to meet the needs of the situation. If the fluid requires close monitoring, the sensors and monitors can be operated more frequently but if the quality of fluid is relatively consistent coming in to and going out of the apparatus, the sensors and monitors can be set to operate less frequently.

Also, the various operating parameters, such as current, voltage, and power applied to the electrodes may be remotely controlled through the communication interface 170. Also, depending on the situation, valves can be opened remotely through the interface 170 to drain the fluid or initiate the regeneration process to clean the electrodes.

The controller 100 can be programmed to call out through the digital communication interface 170 to alert any abnormal conditions of the system 10. If any of the sensors detect abnormal readings, such as abnormally high current in the power supply, moisture at a location not designed to be wet, an incorrect fluid level in the purification tank, or an improper impurity of the treated fluid (i.e. outside the set standard of purity or outside a prescribed range inputted by the operator), the controller 100 can call a designated location to indicate problems with the purification apparatus.

Furthermore, the digital communication interface 170 can communicate to the station that the electrochemical purification apparatus has been tampered with by sensing motion in the apparatus by the security sensor 335. Upon receiving the information that the apparatus has been tampered with, the apparatus can be remotely turned off.

Moreover, when the system senses motion through the security sensor 335, the programmable logic controller 100 can give instruction to the scram circuit 180 to completely disable the system 10. The scram circuit 180 as a theft deterrent can, for example, send enough voltage and amperage to the electrodes 150 to inoperably melt the connections of the electrodes.

In another theft deterrent example, the programmable logic controller 100 can be programmed to self-destruct if no remote access has been made within a given time period. If the apparatus has been tampered with such that digital communication interface has been intentionally rendered inoperable, the programmable logic controller 100 can give instruction to the scram circuit 180 after a period of no contact with a host to render the electrodes inoperable by melting and shorting the connections. It may also send enough voltage to the programmable logic controller 100 to disable the processor completely. The manner in which the system is disabled here is merely exemplary. A number of other equivalent methods of rendering the system inoperable are contemplated and included within this invention.

In another example, the quality of the fluid flowing out of the apparatus can be monitored and certified remotely. The sensors 120, for example, conductivity, pH, and chemical sensors provided at the outlet, can transmit the information regarding the purity of the fluid to a remote station where it can certify the quality of the fluid coming off the apparatus if it meets a certain, predetermined level of purity and/or deionization. The security sensor 335 ensures that the apparatus has not been tampered with to compromise the certification.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An electrical system of an electrochemical purification apparatus comprising:
a plurality of electrodes for deionizing a fluid;
a power supply connected to the electrodes, the power supply providing power to the electrodes while maintaining a predetermined current, a predetermined voltage, or a power within a range at least in some of the electrodes;
a programmable logic controller, connected to the power supply, for controlling the power supply;
at least one monitoring device connected to the programmable logic controller for delivering data to the programmable logic controller; and
a communication interface connected to the programmable logic controller, the communication interface allowing external access to the programmable logic controller to extract data contained in the programmable logic controller or to remotely send instructions and data to the programmable logic controller;
wherein the system is configured such that the electrodes can be moved or physically isolated upon a command such that the electrodes can be regenerated separately from one another.

2. The electrical system according to claim 1, wherein the electrodes act as resistivity or conductivity sensors to monitor how the electrodes have become loaded with impurities from the fluid.

3. The electrical system according to claim 1, wherein the at least one monitoring device includes:
a current monitor and/or a voltage monitor connected between the power supply and the electrodes to monitor current flow and/or voltage delivered to the electrodes from the power supply.

4. The electrical system according to claim 1, wherein the at least one monitoring device includes:
a current monitor connected between the power supply and the electrodes to monitor current flow delivered to the electrodes from the power supply,
wherein regeneration of the electrodes is initiated based on the current flow detected by the current monitor.

5. The electrical system according to claim 1, wherein the at least one monitoring device includes:
a voltage monitor connected between the power supply and the electrodes to monitor voltage delivered to the electrodes from the power supply,
wherein regeneration of the electrodes is initiated based on the voltage detected by the voltage monitor.

6. The electrical system according to claim 1, wherein the at least one monitoring device includes:
a conductivity monitor for measuring conductivity of fluid entering, in, and/or leaving the apparatus,
wherein if the conductivity of the fluid reaches a predetermined threshold value, the fluid is released and regeneration of the electrodes is initiated based on the conductivity times volume of inlet versus outlet fluids, which is a calculation of ionic contaminants captured by the electrodes.

7. The electrical system according to claim 1, wherein the at least one monitoring device includes:
a pH monitor for measuring pH of fluid entering, in, and/or leaving the apparatus.

8. The electrical system according to claim 1, wherein the at least one monitoring device includes:
a chemical sensor for sensing chemical impurities of fluid entering, in, and/or leaving the apparatus.

9. The electrical system according to claim 1, wherein the at least one monitoring device includes:
an inlet fluid monitor for measuring a flow rate of fluid entering the apparatus.

10. The electrical system according to claim 1, wherein the at least one monitoring device includes:
a outlet fluid monitor for measuring a flow rate of fluid exiting the apparatus.

11. The electrical system according to claim 1, wherein the at least one monitoring device includes:
a fluid level sensor for detecting a fluid level in the apparatus.

12. The electrical system according to claim 1, wherein the at least one monitoring device includes:
a moisture sensor for determining whether an area in the electrical chemical system has been compromised by moisture,
wherein if a predetermined level of moisture is detected by the programmable logic controller, the programmable logic controller protects the system by shutting down the system.

13. The electrical system according to claim 1, wherein the at least one monitoring device includes:
a security sensor for reporting unauthorized access or tampering of the electrochemical purification apparatus.

14. The electrical system according to claim 1, wherein the at least one monitoring device includes:
a flow sensor to detect flow of fluid at a designated location in the electrochemical purification apparatus,
wherein if a threshold level of fluid flow is detected at the designated location by the programmable logic controller from the flow sensor, the programmable logic controller instructs the inlet device to decrease or increase the fluid flow.

15. The electrical system according to claim 1, wherein the at least one monitoring device includes:
a flow sensor to detect flow of fluid at a designated location in the electrochemical purification apparatus,
wherein if a predetermined amount of fluid measured by the flow sensor passes through the apparatus, a regeneration of the electrodes is initiated.

16. The electrical system according to claim 1, wherein the programmable logic controller initiates a regeneration of the electrodes after a predetermined time has elapsed since the electrodes have been last regenerated.

17. The electrical system according to claim 1, wherein the at least one monitoring device includes:
an external fluid level sensor for sensing a fluid level of a tank external to the electrochemical purification apparatus.

18. The electrical system according to claim 1, wherein the at least one monitoring device includes:
a chemical sensor for sensing chemical impurities of fluid in a tank external to the electrochemical purification apparatus.

19. The electrical system according to claim 1, wherein the at least one monitoring device includes:
a flow rate loss monitor for monitoring a back pressure of flowing fluid in a tank containing the electrodes,
wherein if the back pressure exceeds a threshold value, the programmable logic controller sends out a warning to signify a need to regenerate the electrodes.

20. The electrical system according to claim 1, wherein the at least one monitoring device includes:
an array of sensors distributed at designated locations in the electrochemical purification apparatus to monitor for fluid leakage,
wherein if the programmable logic controller detects fluid leakage from any of the sensors, the programmable logic controller instructs the intake device to stop the fluid flow.

21. The electrical system according to claim 1, further comprising:
a flow controller, connected to the programmable logic controller, for controlling an inlet device and an outlet device, which respectively allows fluid to access the electrodes and allows the fluid to exit the apparatus.

22. The electrical system according to claim 1, further comprising:
a current controller, connected to the programmable logic controller, for controlling current flow within the system.

23. The electrical system according to claim 1,
wherein the communication interface remotely transmits information collected by the monitoring devices to a remote station at which the information may be certified, and/or allows the remote station to send programs and parameters to the programmable logic controller.

24. The electrical system according to claim 1, further comprising:
a scram circuit for disabling the system when the system senses tampering without having the scram circuit turned off.

25. The electrical system according to claim 1, wherein each electrode is a non-sacrificial electrode made of carbonized material.

26. The electrical system according to claim 1, further comprising:
additional power supplies for supplying power to additional electrodes.

27. An electrical system of an electrochemical purification apparatus comprising:
sets of electrodes for deionizing fluid passing through or past the electrodes;
a plurality of power supplies, each connected and providing power to each set of electrodes while maintaining a predetermined current, a predetermined voltage, or a power within a range;
a programmable logic controller, connected to the power supplies, for controlling the power supplies;
one or more monitoring devices connected to the programmable logic controller for delivering data regarding the system to the programmable logic controller; and
a communication interface connected to the programmable logic controller, the communication interface allowing external access to the programmable logic controller to extract data contained in the programmable logic controller or to remotely send instructions and data to the programmable logic controller.

28-52. (canceled)

53. An electrical system of an electrochemical purification apparatus comprising:
a plurality of electrodes for deionizing fluids;
a power supply connected to the electrodes, the power supply providing power to the electrodes while maintaining a predetermined current, a predetermined voltage, or a power within a range at least in some of the electrodes;
a programmable logic controller, connected to the power supply, for controlling the power supply;
a plurality of monitoring devices connected to the programmable logic controller for delivering data regarding the system to the programmable logic controller, said plurality of monitoring devices selected from a group consisting of a current monitor, a voltage monitor, a conductivity monitor, a pH monitor, a chemical sensor, an inlet sensor, an outlet sensor, an internal fluid sensor, a moisture sensor, a security sensor, a flow sensor, an external fluid level sensor, an external tank chemical sensor, and a flow rate loss sensor;
a scram circuit connected to the programmable logic controller to disable the system if one of the monitoring devices senses a security violation;
a flow controller connected to the programmable logic controller to control the flow of the fluid in the apparatus;
a current controller connected to the programmable logic controller to control the current flowing within the electrical system; and
a communication interface connected to the programmable logic controller, the communication interface allowing external access to the programmable logic controller to extract data contained in the programmable logic controller or to remotely send instructions and data to the programmable logic controller.

54. An electrical system of an electrochemical purification apparatus comprising:
sets of electrodes for deionizing fluid passing through or past the electrodes;
a plurality of power supplies, each connected and providing power to each set of electrodes while maintaining a predetermined current, a predetermined voltage, or a power within a range;
a programmable logic controller, connected to the power supplies, for controlling the power supplies;
a plurality of monitoring devices connected to the programmable logic controller for delivering data regarding the system to the programmable logic controller, said plurality of monitoring devices selected from a group consisting of a current monitor, a voltage monitor, a conductivity monitor, a pH monitor, a chemical sensor, an inlet sensor, an outlet sensor, an internal fluid sensor, a moisture sensor, a security sensor, a flow sensor, an external fluid level sensor, an external tank chemical sensor, and a flow rate loss sensor;
a scram circuit connected to the programmable to disable the system if one of the monitoring devices senses a security violation;
a flow controller connected to the programmable logic controller to control the flow of the fluid in the apparatus;
a current controller connected to the programmable logic controller to control the current flowing within the electrical system; and
a communication interface connected to the programmable logic controller, the communication interface allowing external access to the programmable logic controller to extract data contained in the programmable logic controller or to remotely send instructions and data to the programmable logic controller.
